(19) United States
(12) Patent Application Publication
(10) Pub. No.: US 2026/0181365 A1
(43) Pub. Date: Jun. 25, 2026

(54) ELECTRONIC DEVICE AND METHOD FOR CONTROLLING THE SAME

(71) Applicant: SAMSUNG ELECTRONICS CO., LTD., Suwon-si (KR)

(72) Inventors: Sanghyuk PARK, Suwon-si (KR); Kiyong LEE, Suwon-si (KR); Chaekyu LEE, Suwon-si (KR)

(73) Assignee: SAMSUNG ELECTRONICS CO., LTD., Suwon-si (KR)

(21) Appl. No.: 19/541,049

(22) Filed: Feb. 16, 2026

Related U.S. Application Data
(63) Continuation-in-part of application No. 18/140,755, filed on Apr. 28, 2023, now Pat. No. 12,581,546.
Application No. 18/140,755 is a continuation of application No. PCT/KR2023/005038, filed on Apr. 13, 2023.

(30) Foreign Application Priority Data
Jul. 6, 2022 (KR) 10-2022-0083400

(51) Int. Cl. H04W 4/80; G06F 1/16; G06F 3/0346; H04W 12/06

(52) U.S. Cl. CPC H04W 4/80; G06F 1/1632; G06F 3/0346; H04W 12/06

(57) ABSTRACT

An electronic device and method thereof. The electronic device includes at least one sensor; a communicator including circuitry configured to perform wireless communication; an accessory detachably coupled to the electronic device; and at least one processor configured to, based on detecting coupling of the accessory to the electronic device, control the communicator to execute pairing with the accessory, and validate the pairing with the accessory based on at least one of state information or operation information received from the accessory corresponding to at least one of operation command information transmitted to the accessory or sensing information of the at least one sensor.

### CROSS-REFERENCE TO RELATED APPLICATION

This application is related to and is a continuation-in-part of U.S. Ser. No. 18/140,755, filed Apr. 28, 2023, which is a continuation application, under 35 U.S.C. § 111 (a), of international application No. PCT/KR2023/005038, filed on Apr. 13, 2023, which claims priority under 35 U. S. C. § 119 to Korean Patent Application No. 10-2022-0083400, filed Jul. 6, 2022, the disclosures of which are incorporated herein by reference in their entirety.

### BACKGROUND

### Field

The disclosure relates to an electronic device which exchanges information with an accessory.

### Discussion of Related Art

An electronic device may be generally coupled to an accessory such as a battery and may communicate with the accessory via a line. For example, the electronic device may receive information, e.g., a remaining charge level, from the battery.

Specifically, the accessory needs to be coupled or decoupled, so the electronic device may be equipped with a terminal in addition to a line for wired connection and connected to the accessory in a normal wired communication scheme, e.g., with a universal asynchronous receiver/transmitter (UART).

However, repeated coupling and decoupling of the accessory may make the terminal deteriorate, and especially when a shock is applied to the electronic device, deterioration of the terminal may be accelerated, in which case a success rate of communication connection may decrease.

### SUMMARY

According to an embodiment, an electronic device includes at least one sensor; a communicator including circuitry configured to perform wireless communication; and a controller configured to: in response to detection of coupling of the electronic device to an accessory of the electronic device based on an output of the at least one sensor, control the communicator to execute pairing according to an advertising signal having a highest strength among advertising signals outputted by a plurality of accessories of a same type as a type of the accessory coupled to the electronic device, and determine whether a paired accessory, which is paired with the communicator according to the pairing, corresponds to the accessory coupled to the electronic device based on whether state information received from the paired accessory corresponds to state information of the electronic device.

The controller may control the communicator to scan for the advertising signals outputted by the plurality of accessories of the same type as the type of the accessory coupled to the electronic device in response to the detection of the coupling of the accessory.

The controller may control the communicator to transmit or receive state information to or from the paired accessory.

The controller may release the pairing with the paired accessory provided the paired accessory does not correspond to the accessory coupled to the electronic device.

The controller may restrict the pairing with the paired accessory in response to the paired accessory not corresponding to the accessory coupled to the electronic device, and control the communicator to pair with another accessory based on a strength of the advertising signals.

The state information of the electronic device may include at least one of sensing information received from the at least one sensor or operation command information.

Based on the accessory coupled to the electronic device being a battery, the controller may determine whether the paired accessory which is a battery corresponds to the accessory coupled to the electronic device as the battery based on whether discharge state information received from the paired accessory as the corresponds to the operation command information or sensing information of the at least one sensor.

The electronic device may be a vacuum cleaner and based on the accessory coupled to the electronic device being a brush, the controller may determine whether the paired accessory which is a brush corresponds to the accessory coupled to the electronic device as the brush based on whether state information received from the paired accessory as the brush corresponds to the operation command information or sensing information of a current applied to the accessory coupled to the electronic device as the brush.

The electronic device may be a vacuum cleaner and based on the accessory coupled to the electronic device being a docking station and state information received from the docking station indicating that a dust discharge course is performed, the controller may determine whether the paired accessory as the docking station corresponds to the accessory coupled to the electronic device as the docking station based on whether the state information received from the paired accessory as the docking station corresponds to the operation command information or sensing information of a pressure sensor of the at least one sensor.

The electronic device may be a vacuum cleaner and based on the accessory coupled to the electronic device being a docking station and state information received from the docking station indicating that a charge course is performed, the controller may determine whether the paired accessory as the docking station corresponds to the accessory coupled to the electronic device as the docking station based on whether state information received from the paired accessory as the docking station corresponds to the operation command information or sensing information of a charge current of a battery coupled to the electronic device.

According to an embodiment, a method of controlling an electronic device including at least one sensor and a communicator to perform wireless communication includes, in response to detection of coupling of the electronic device to an accessory of the electronic device based on an output of the at least one sensor, controlling the communicator execute pairing according to an advertising signal having a highest strength among advertising signals outputted by a plurality of accessories of a same type as a type of the accessory coupled to the electronic device; and determining whether a paired accessory, which is paired with the communicator according to the pairing, corresponds to the accessory coupled to the electronic device based on whether state information received from the paired accessory corresponds to state information of the electronic device.

The method may further include controlling the communicator to scan for the advertising signals outputted by the plurality of accessories of the same type as the type of the accessory coupled to the electronic device in response to the detection of the coupling of the accessory.

The method may further include controlling the communicator to transmit or receive state information to or from the paired accessory.

The method may further include releasing the pairing with the paired accessory in response to the paired accessory not corresponding to the coupled accessory.

The method may further include restricting the pairing with the paired accessory provided the paired accessory dose not correspond to the accessory coupled to the electronic device; and controlling the communicator to pair with another accessory based on a strength of the advertising signals.

The state information of the electronic device may include at least one of sensing information received from the at least one sensor or operation command information.

The determining of whether the paired accessory corresponds to the accessory may include, based on the accessory coupled to the electronic device being a battery, determining whether the paired accessory which is a battery corresponds to the accessory coupled to the electronic device as the battery based on whether discharge state information received from the paired accessory as the battery corresponds to the operation command information or sensing information of the at least one sensor.

The electronic device may be a vacuum cleaner and the determining of whether the paired accessory corresponds to the accessory may include, based on the accessory coupled to the electronic device being a brush, determining whether the paired accessory which is a brush corresponds to the accessory coupled to the electronic device as the brush based on whether state information received from the paired accessory as the brush corresponds to the operation command information or sensing information of a current applied to the accessory coupled to the electronic device as the brush.

The electronic device may be a vacuum cleaner and the determining of whether the paired accessory corresponds to the coupled accessory may include, based on the accessory coupled to the electronic device being a docking station and state information received from the docking station indicating that a dust discharge course is performed, determining whether the paired accessory as the docking station corresponds to the accessory coupled to the electronic device as the docking station based on whether the state information received from the paired accessory as the docking station corresponds to the operation command information or sensing information of a pressure sensor of the at least one sensor.

The electronic device may be a vacuum cleaner and the determining of whether the paired accessory corresponds to the coupled accessory may include, based on the accessory coupled to the electronic device being a docking station and state information received from the docking station indicating that a charging course is performed, determining whether the paired accessory as the docking station corresponds to the accessory coupled to the electronic device as the docking station based on whether the state information received from the paired accessory as the docking station corresponds to the operation command information or sensing information of a charge current of a battery coupled to the electronic device.

According to an embodiment, an electronic device includes at least one sensor; a communicator including circuitry configured to perform wireless communication; an accessory detachably coupled to the electronic device; and at least one processor configured to, based on detecting coupling of the accessory to the electronic device, control the communicator to execute pairing with the accessory, and validate the pairing with the accessory based on at least one of state information or operation information received from the accessory corresponding to at least one of operation command information transmitted to the accessory or sensing information of the at least one sensor.

According to an embodiment, a method of controlling an electronic device includes, based on detecting coupling of an accessory to the electronic device, controlling a communicator to execute pairing with the accessory, and validating the pairing with the accessory based on at least one of state information or operation information received from the accessory corresponding to at least one of operation command information transmitted to the accessory or sensing information of at least one sensor.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which

FIG. 1 is an exterior view of an electronic device, according to an embodiment.

FIG. 2 is a control block diagram of an electronic device, according to an embodiment.

FIG. 3 is a signal flowchart of an electronic device pairing with a coupled accessory, according to an embodiment.

FIG. 4 is a diagram for describing an example of state information transmitted or received by an electronic device to or from an accessory, according to an embodiment.

FIG. 5 is a diagram for describing an occasion when an electronic device makes a wrong connection with an accessory other than a coupled accessory, according to an embodiment.

FIG. 6 is a signal flowchart of an electronic device determining validity of pairing with an accessory, according to an embodiment.

FIG. 7 illustrates an example of an electronic device determining validity of pairing with a battery, according to an embodiment.

FIG. 8 illustrates an example of an electronic device determining validity of pairing with a brush, according to an embodiment.

FIG. 9 illustrates an example of an electronic device determining validity of pairing with a docking station, according to an embodiment.

FIG. 10 is a flowchart of performing wireless connection with an accessory in a method of controlling an electronic device, according to an embodiment.

FIG. 11 is a flowchart of determining validity of wireless connection with an accessory in a method of controlling an electronic device, according to an embodiment.

### DETAILED DESCRIPTION OF EXEMPLARY EMBODIMENTS

Embodiments and features as described and illustrated in the disclosure are merely examples, and there may be various modifications replacing the embodiments and drawings at the time of filing this application.

It will be further understood that the term “connect” or its derivatives refer both to direct and indirect connection, and the indirect connection includes a connection over a wireless communication network.

The terminology used herein is for the purpose of describing particular embodiments only and is not intended to limit the disclosure. It is to be understood that the singular forms “a,” “an,” and “the” include plural references unless the context clearly dictates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

The terms including ordinal numbers like “first” and “second” may be used to explain various components, but the components are not limited by the terms. The terms are only for the purpose of distinguishing a component from another. Thus, a first element, component, region, layer or room discussed below could be termed a second element, component, region, layer or section without departing from the teachings of the disclosure.

Furthermore, the terms, such as “˜ part”, “˜ block”, “˜ member”, “˜ module”, etc., may refer to a unit of handling at least one function or operation. For example, the terms may refer to at least one process handled by hardware such as field-programmable gate array (FPGA)/application specific integrated circuit (ASIC), etc., software stored in a memory, or at least one processor.

The disclosure provides an electronic device and method for controlling the same, which supports wireless connection to an accessory without user intervention and assists wireless connection by detecting an occasion of wrong connection of the same type of accessory located in the vicinity.

According to an electronic device and method for controlling the same in an embodiment may support wireless connection with an accessory without user intervention and assist the wireless connection by detecting an occasion of wrong connection with the same type of accessory located in the vicinity.

Reference numerals used for method steps are just used to identify the respective steps, but not to limit an order of the steps. Thus, unless the context clearly dictates otherwise, the written order may also be practiced otherwise.

Reference will now be made in detail to embodiments of the disclosure, which are illustrated in the accompanying drawings.

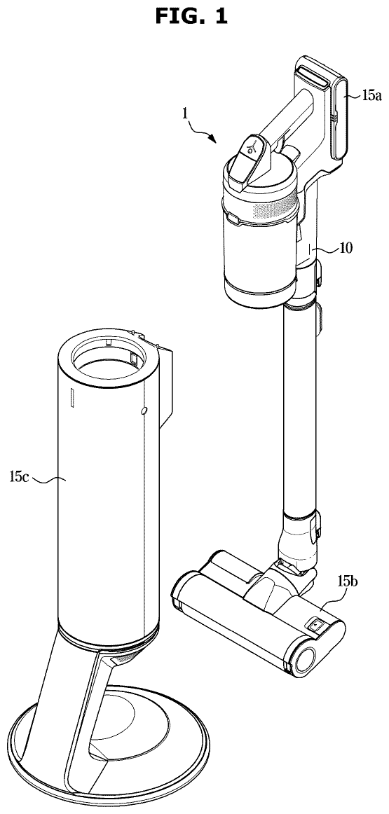

FIG. 1 is an exterior view of an electronic device, according to an embodiment.

Referring to FIG. 1, an electronic device 1 in an embodiment may include a main body 10 and accessories 15a, 15b, and 15c (15) that may be coupled to the main body 10.

For example, the electronic device 1 may correspond to a vacuum cleaner as shown in FIG. 1, and the accessories 15 may include a battery 15a, a brush 15b and a docking station 15c.

The type of the electronic device 1 is not, however, limited thereto, and any type of electronic device is used without limitation as long as the electronic device is coupled with an accessory such as a battery.

Furthermore, the type of the accessory 15 is not limited to the above examples, and any type of accessory is used without limitation as long as the accessory may be coupled or decoupled for an operation of the electronic device 1.

For example, the accessory 15 may include a moving device having at least one motor. The moving device may be, for example, a drive wheel module, a locomotion unit, a propulsion module, or any other device capable of generating movement through a motor. The moving device may be detachably coupled to the electronic device 1 and may wirelessly communicate with the electronic device 1 via the communication module 120.

Furthermore, the accessory 15 may include an articulated device. The articulated device may have at least one joint connecting two or more link members. The joint may be a revolute joint, a prismatic joint, a spherical joint, or any other type of joint that allows relative movement between the link members. The articulated device may be, for example, a robot arm, a robot leg, a robotic limb, a manipulator, or any other articulated mechanism that can be detachably coupled to the electronic device 1.

The articulated device may be configured to perform at least one of gripping an object, lifting an object, manipulating an object, supporting the electronic device 1, or moving the electronic device 1. For example, a robot arm type articulated device may be configured to grip, lift, or manipulate an object for the electronic device 1, and a robot leg type articulated device may be configured to support the electronic device 1 or to provide locomotion for the electronic device 1.

In the case where the articulated device is configured to grip an object, the state information or operation information received from the articulated device may include grip force information, gripper opening distance information, or contact detection information. In the case where the articulated device is configured to lift an object, the state information or operation information may include load information, elevation information, or lifting speed information. In the case where the articulated device is configured to support or move the electronic device 1, the state information or operation information may include ground contact force information, balance state information, gait cycle information, or stride length information.

Furthermore, the electronic device 1 may be a robotic device, a mobile robot, a robot cleaner, or any other moving device to which a moving device or an articulated device may be coupled as an accessory.

Furthermore, a plurality of accessories 15 may be attachable to the electronic device 1. The plurality of accessories 15 may be of the same type or of different types. For example, the electronic device 1 may be simultaneously coupled to two moving devices, or may be simultaneously coupled to one moving device and one articulated device.

The traditional electronic device may be electrically connected to the accessory via a power line for power and a communication line for communication.

As compared to the traditional electronic device, the electronic device 1 according to the disclosure may also be electrically connected to the accessory 15 via the power line for power but may perform wireless communication with the accessory 15 without the communication line for communication.

Hence, without the communication line and associated terminal, costs and weight may be reduced and electro-static discharge (ESD) that may occur due to exposure of the terminal may be prevented.

Furthermore, through the wireless connection with the accessory 15, the electronic device 1 of the disclosure may prevent reduction in communication efficiency due to deterioration of the communication line and the terminal from repetitive coupling and decoupling of the accessory 15 and operations of the electronic device.

Moreover, the electronic device 1 in the disclosure may increase accuracy in wireless connection by detecting an event of wireless connection with another accessory of the same type located in the vicinity instead of the coupled accessory 15 and correcting the wireless connection to the coupled accessory 15.

Configuration and operations of the electronic device 1 have thus far been briefly described. Control configuration of the electronic device 1 will now be described in detail.

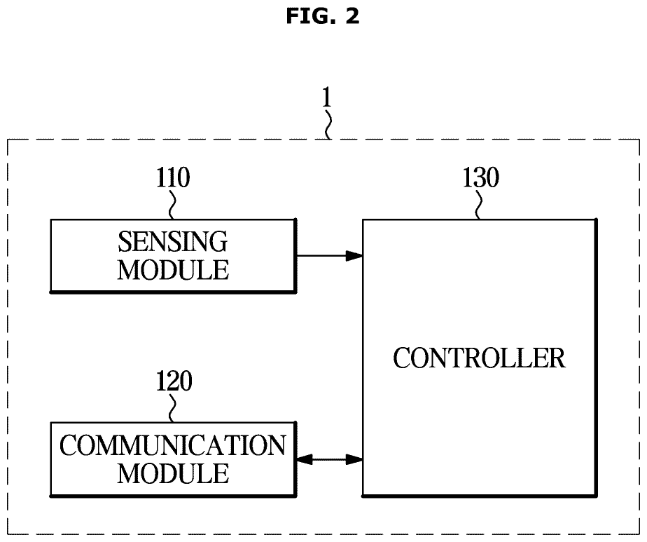

FIG. 2 is a control block diagram of the electronic device 1, according to an embodiment.

Referring to FIG. 2, the electronic device 1 in an embodiment includes a sensing module 110 for detecting various types of operation data of the electronic device 1, a communication module 120 for performing wireless communication with the accessory 15, and a controller 130 for controlling the communication module 120 to perform wireless connection with the accessory 15 when the accessory 15 is coupled thereto and determining validity of the wireless connection.

The control configuration of the electronic device 1 as shown in FIG. 2 is merely an example, and a component that is not shown in FIG. 2 may be added thereto or some of the components shown in FIG. 2 may be omitted.

In an embodiment, the sensing module 110 may detect coupling of the accessory 15. The coupling of the accessory may include a physical coupling of the accessory. The physical coupling may include structural connection, electrical connection and/or wired connection. The sensing module 110 may include at least one sensor.

For example, the sensing module 110 may include a current sensor for detecting a current applied to the accessory 15 or applied from the accessory 15, and detect coupling of the accessory 15 through detection of a current in a power line connected to the accessory 15. In this case, the controller 130 may determine coupling of the accessory 15 by receiving current data detected from the sensing module 110.

Furthermore, the sensing module 110 may include a pressure sensor for detecting pressure applied by coupling of the accessory 15 or a voltage sensor for measuring a voltage at a voltage terminal connected by the coupling of the accessory 15.

The type of the sensing module 110 for detecting coupling of the accessory 15 is not, however, limited to the above example, and there is no limitation on the type as long as it is a known type of coupling detection sensor.

Furthermore, the sensing module 110 in an embodiment may detect an operation state of the electronic device 1.

For example, when the electronic device 1 is a vacuum cleaner, the accessory 15 corresponds to the docking station 15c and a dust discharge course for discharging dust in a dust collection bin of the vacuum cleaner is being performed, the sensing module 110 may include a pressure sensor for detecting a change in atmospheric pressure due to the performing of the dust discharge course.

In an embodiment, the communication module 120 may perform wireless communication with the accessory 15. For this, the communication module 120 may be provided as a known type of wireless communication module, e.g., a Bluetooth low energy (BLE) communication module.

The accessory 15 may also include a wireless communication module for wireless communication with the electronic device 1.

In an embodiment, when coupling of the accessory 15 is detected based on an output of the sensing module 110, the controller 130 may control the communication module 120 to pair with an accessory having the highest strength of an advertising signal among the plurality of accessories 15 of the same type as the type of the coupled accessory 15. The controller 130 may identify a type of the accessory 15 coupled to the electronic device 1. The controller 130 may control the communication module 120 to execute pairing according to an advertising signal having a highest strength among advertising signals outputted by the plurality of accessories 15 of the same type as the type of the coupled accessory 15

In other words, the controller 130 may control the communication module 120 to scan the advertising signal(s) when coupling of the accessory 15 is detected.

Furthermore, the controller 130 may control the communication module 120 to transmit or receive state information to or from the accessory 15 when the accessory 15 is paired with. In this case, the state information of the accessory 15 may include at least one of a sensing information value or an operation setting value of the accessory 15. Furthermore, the state information of the electronic device 1 may include at least one of operation command information of the electronic device 1 or sensing information of the sensing module 110.

Furthermore, when the accessory 15 includes a moving device, the state information or operation information received from the moving device may include torque information indicating a torque generated by the motor of the moving device or a torque applied to a drive shaft or wheel of the moving device. The state information or operation information may further include at least one of position information indicating a current position of the moving device or velocity information indicating a linear velocity, an angular velocity, or a rotational speed of the moving device or a component thereof. Furthermore, when the moving device has a motor, the state information or operation information may include motor current information indicating a current flowing through the motor.

When the accessory 15 includes an articulated device having a joint, the state information or operation information received from the articulated device may include joint angle information. The joint angle information may indicate an angle of the joint at a specific point in time, that is, an instantaneous joint angle. Furthermore, the joint angle information may include angular change information indicating a change in the joint angle over time. The angular change information may represent a trajectory of joint movement, an angular velocity of the joint, an angular acceleration of the joint, or a sequence of angular positions over a predetermined time period. In other words, the joint angle information may encompass both a static angular position and dynamic angular variation of the joint.

The state information or operation information received from the accessory 15 may further include output information indicating at least one of a light emission, a display output, or a sound output of the accessory 15. The output information may be generated by the accessory 15 in response to the operation command information transmitted from the electronic device 1, or may be generated autonomously by the accessory 15 to indicate an operational state thereof.

The state information and the operation information may be collectively referred to as information received from the accessory 15 that represents a current state, a performed operation, or a sensed condition of the accessory 15. The operation information may include information indicating an operation performed by the accessory 15, such as a movement operation, a gripping operation, a lifting operation, or any other operation performed in response to the operation command information. The operation information may further include a result of the operation, an execution status of the operation, or an error status indicating that the commanded operation could not be performed. The controller 130 may use one or both of the state information and the operation information to determine whether the pairing with the accessory 15 is valid.

In an embodiment, the controller 130 may determine whether the paired accessory 15 corresponds to the coupled accessory 15 based on whether the state information received from the paired accessory 15 corresponds to the state information of the electronic device 1.

In an embodiment, the controller 130 may perform a validation procedure by transmitting a predetermined test command to the accessory 15 and determining whether a response received from the paired accessory 15 corresponds to an expected response for the test command. The test command may include, for example, an instruction to rotate a motor at a specific speed for a specific duration, to move a joint to a specific angle, or to emit light with a specific pattern, and the controller 130 may determine that the pairing is valid when the response corresponds to the expected response within a predetermined tolerance.

The controller 130 may determine that the state information or operation information received from the paired accessory 15 corresponds to the operation command information or the sensing information when a difference between the received information and the expected information is within a predetermined threshold. The predetermined threshold may be set based on a type of the accessory 15, a type of the information, or an operating condition of the electronic device 1. For example, when the operation command information instructs a motor to rotate at 1000 revolutions per minute and the motor current information received from the paired accessory 15 indicates a rotational speed within a range of 950 to 1050 revolutions per minute, the controller 130 may determine that the motor current information corresponds to the operation command information.

Furthermore, the controller 130 may determine whether the pairing is valid based on a temporal correlation between the operation command information transmitted to the accessory 15 and the state information or operation information received from the paired accessory 15. For example, the controller 130 may determine that the pairing is valid when the state information or operation information is received within a predetermined time period after the operation command information is transmitted. When the state information or operation information is received after the predetermined time period has elapsed, or when a change in the state information or operation information does not temporally correspond to a change in the operation command information, the controller 130 may determine that the pairing is not valid.

For example, when the same type of accessory 15 as the coupled accessory 15 is located around the electronic device 1 and the nearby accessory 15 instead of the coupled accessory 15 is paired with the electronic device 1 due to noise or other reasons, the state information received from the paired accessory 15 may not correspond to the state information of the electronic device 1.

Specifically, when the coupled accessory 15 is the battery 15a, the controller 130 may determine whether the paired battery 15a corresponds to the coupled battery 15a based on whether discharge state information received from the paired battery 15a corresponds to the operation command information of the electronic device 1 or sensing information of a discharge current of the coupled battery 15a.

When the electronic device 1 is a vacuum cleaner and the coupled accessory 15 is the brush 15b, the controller 130 may determine whether the paired brush 15b corresponds to the coupled brush based on whether the state information received from the paired brush 15b corresponds to the operation command information of the electronic device 1 or sensing information of a current applied to the coupled brush 15b.

When the electronic device 1 is a vacuum cleaner, the coupled accessory 15 is the docking station 15c, and the state information received from the paired docking station 15c indicates that a dust discharge course is performed, the controller 130 may determine whether the paired docking station 15c and the coupled docking station 15c correspond to each other based on sensing information of the pressure sensor of the sensing module 110 corresponds to the performing of the dust discharge course.

When the electronic device 1 is a vacuum cleaner, the coupled accessory 15 is the docking station 15c, and the state information received from the paired docking station 15c indicates that a charging course is performed, the controller 130 may determine whether the paired docking station 15c corresponds to the coupled docking station 15c based on whether the state information corresponds to the operation command information of the electronic device 1 or sensing information of a charge current of the coupled battery 15a.

When the accessory 15 includes a moving device, the controller 130 may determine whether the pairing with the moving device is valid based on whether the torque information received from the paired moving device corresponds to at least one of operation command information transmitted to the moving device or sensing information of the sensing module 110. For example, when the controller 130 transmits an operation command to the moving device to drive at a specific speed or in a specific direction, the controller 130 may determine that the pairing is valid when the torque information received from the paired moving device corresponds to the transmitted operation command. Conversely, when the torque information received from the paired moving device does not correspond to the operation command information or when the torque information indicates a torque value that is inconsistent with the sensing information of the sensing module 110, the controller 130 may determine that the pairing is not valid.

Furthermore, the controller 130 may determine whether the pairing with the moving device is valid based on whether the at least one of position information or velocity information received from the paired moving device corresponds to at least one of the operation command information transmitted to the moving device or the sensing information of the sensing module 110. For example, when the controller 130 transmits an operation command to the moving device to move to a specific position or at a specific velocity, the controller 130 may compare the position information or velocity information received from the paired moving device with the transmitted operation command to determine validity of the pairing. Furthermore, the sensing module 110 may include an inertial measurement unit (IMU), an accelerometer, a gyroscope, or an encoder for detecting movement of the electronic device 1. When the moving device is properly coupled to the electronic device 1, movement of the moving device may cause corresponding movement of the electronic device 1 that is detectable by the sensing module 110. Accordingly, the controller 130 may determine whether the pairing is valid based on whether the velocity information or position information received from the paired moving device corresponds to the movement detected by the sensing module 110.

When the accessory 15 includes a moving device having a motor, the controller 130 may determine whether the pairing is valid based on whether the motor current information received from the paired moving device corresponds to at least one of the operation command information transmitted to the moving device or the sensing information of the sensing module 110. For example, when the controller 130 transmits an operation command to the motor to rotate at a specific speed, the motor current information received from the paired moving device should correspond to the expected motor current for the commanded operation. Furthermore, the sensing module 110 may include a current sensor for measuring a current supplied to the accessory 15 through a power line. When the motor current information received from the paired moving device does not correspond to the current measured by the current sensor, the controller 130 may determine that the paired moving device does not correspond to the coupled moving device.

When the accessory 15 includes an articulated device having a joint, the controller 130 may determine whether the pairing with the articulated device is valid based on whether the joint angle information received from the paired articulated device corresponds to at least one of the operation command information transmitted to the articulated device or the sensing information of the sensing module 110. For example, when the controller 130 transmits an operation command to the articulated device to move the joint to a target angle or to perform a specific motion trajectory, the controller 130 may compare the joint angle information received from the paired articulated device with the commanded target angle or trajectory. Furthermore, the controller 130 may determine validity of the pairing based on whether the angular change information included in the joint angle information corresponds to the operation command information. For example, when the controller 130 transmits an operation command instructing the articulated device to rotate a joint from a first angle to a second angle at a specific angular velocity, the controller 130 may determine the pairing is valid when the angular change information indicates a transition from the first angle to the second angle at the commanded angular velocity. Conversely, when the angular change information indicates that the joint remains stationary while the operation command instructs movement, or when the angular change information indicates movement in a direction different from the commanded direction, the controller 130 may determine that the pairing is not valid.

Furthermore, the sensing module 110 may include a force sensor, a torque sensor, or an acceleration sensor disposed at or near a coupling portion between the electronic device 1 and the articulated device. When the articulated device moves its joint, a corresponding force or vibration may be transmitted to the electronic device 1 through the coupling portion. Accordingly, the controller 130 may determine whether the joint angle information or the angular change information received from the paired articulated device corresponds to the sensing information detected by the sensing module 110.

In an embodiment, the controller 130 may determine whether the pairing with the accessory 15 is valid based on output information received from the accessory 15. The light emission may include an emission from a light emitting diode (LED), a laser diode, an organic light emitting diode (OLED), or any other light source provided in the accessory 15. The output information related to the light emission may include information identifying a specific light emitting object among a plurality of light emitting objects of the accessory 15, a light emission form or pattern, a luminous intensity or brightness level, and a blinking pattern. The blinking pattern may include an on/off frequency, a duty cycle, a blinking sequence, or a coded blinking pattern corresponding to specific information.

For example, the controller 130 may transmit an operation command to the accessory 15 to emit light from a specific light emitting object (e.g., a first LED among a plurality of LEDs) at a specific luminous intensity with a specific blinking pattern. The controller 130 may then determine whether the output information received from the paired accessory 15 corresponds to the transmitted operation command. When the output information indicates that the specific light emitting object emitted light at the commanded luminous intensity with the commanded blinking pattern, the controller 130 may determine that the pairing is valid.

Furthermore, the sensing module 110 may include an optical sensor, a photodetector, an ambient light sensor, or a camera for detecting the light emission from the accessory 15. The controller 130 may determine whether the pairing is valid based on whether the light emission detected by the sensing module 110 corresponds to the output information received from the paired accessory 15. For example, when the output information received from the paired accessory 15 indicates that the accessory 15 emits light with a first blinking pattern but the optical sensor of the sensing module 110 detects a second blinking pattern different from the first blinking pattern, or detects no light emission, the controller 130 may determine that the paired accessory 15 does not correspond to the coupled accessory 15.

In another example, the controller 130 may transmit an operation command to the accessory 15 to change a color of the light emission, a wavelength of the light emission, or an emission direction of the light emitting object. The controller 130 may then compare the output information received from the paired accessory 15 with the sensing information of the sensing module 110 to determine whether the light emission change detected by the sensing module 110 corresponds to the commanded change, thereby validating the pairing.

The display output may include a visual output presented on a display panel, a screen, or an indicator of the accessory 15. The output information related to the display output may include information about content displayed, a display pattern, a color, or a brightness of the display. For example, the controller 130 may transmit an operation command to the accessory 15 to display a specific icon, pattern, color, or text on the display of the accessory 15, and determine whether the output information received from the paired accessory 15 indicates that the commanded display content was presented.

The sound output may include an audible output generated by a speaker, a buzzer, or a vibration motor of the accessory 15. The output information related to the sound output may include information about a frequency, a volume, a tone pattern, a melody, or a duration of the sound. For example, the controller 130 may transmit an operation command to the accessory 15 to generate a specific sound or tone pattern, and determine whether the output information received from the paired accessory 15 indicates that the commanded sound was generated. Furthermore, the sensing module 110 may include a microphone or a vibration sensor, and the controller 130 may determine whether the sound or vibration detected by the sensing module 110 corresponds to the sound output indicated by the output information received from the paired accessory 15.

The controller 130 may combine a plurality of types of output information to determine validity of the pairing. For example, the controller 130 may transmit an operation command to the accessory 15 to simultaneously emit light with a specific blinking pattern, display a specific icon, and generate a specific sound, and determine whether the combined output information received from the paired accessory 15 corresponds to the combined operation command, thereby increasing accuracy of the pairing validation.

In an embodiment, the controller 130 may determine whether the pairing is valid based solely on whether the output information received from the paired accessory 15 corresponds to the operation command information transmitted to the accessory 15, without relying on the sensing information of the sensing module 110. For example, when the controller 130 transmits an operation command to the accessory 15 to emit light with a specific blinking pattern and the output information received from the paired accessory 15 confirms that the commanded blinking pattern was executed, the controller 130 may determine that the pairing is valid based on the correspondence between the output information and the operation command information. Similarly, when the controller 130 transmits an operation command to generate a specific sound or to display a specific pattern and the output information confirms execution of the commanded output, the controller 130 may determine that the pairing is valid without detecting the output through the sensing module 110.

In an embodiment, the controller 130 may release the pairing with the paired accessory 15 when the paired accessory 15 does not correspond to the coupled accessory 15.

In an embodiment, when the paired accessory 15 does not correspond to the coupled accessory 15, the controller 130 may restrict pairing with the paired accessory 15 and control the communication module 120 to pair with another accessory 15 based on strength of the advertising signal.

In an embodiment, a plurality of accessories 15 may be simultaneously coupled to the electronic device 1, and the controller 130 may be configured to independently execute pairing and determine validity of pairing for each of the plurality of accessories 15. For example, when a first accessory and a second accessory are simultaneously coupled to the electronic device 1, the controller 130 may independently control the communication module 120 to execute pairing with the first accessory and the second accessory, and independently determine validity of each pairing.

The controller 130 may manage pairing and validity determination for each accessory 15 independently, so that a determination that a pairing with a first accessory is invalid does not affect the pairing with a second accessory. Furthermore, the controller 130 may execute the pairing with the plurality of accessories 15 sequentially or simultaneously. When executed sequentially, the controller 130 may complete pairing and validity determination for a first accessory before proceeding to a next accessory. When executed simultaneously, the controller 130 may manage a plurality of concurrent pairing sessions through the communication module 120, each session being independently validated.

The controller 130 may include at least one memory for storing a program for carrying out the aforementioned and following operations, and at least one processor for executing the program. In a case that the memory and the processor are each provided in the plural, they may be integrated in a single chip or physically distributed.

The control configuration of the electronic device 1 has thus far been described. How the electronic device 1 performs wireless connection with the accessory 15 will now be described in detail.

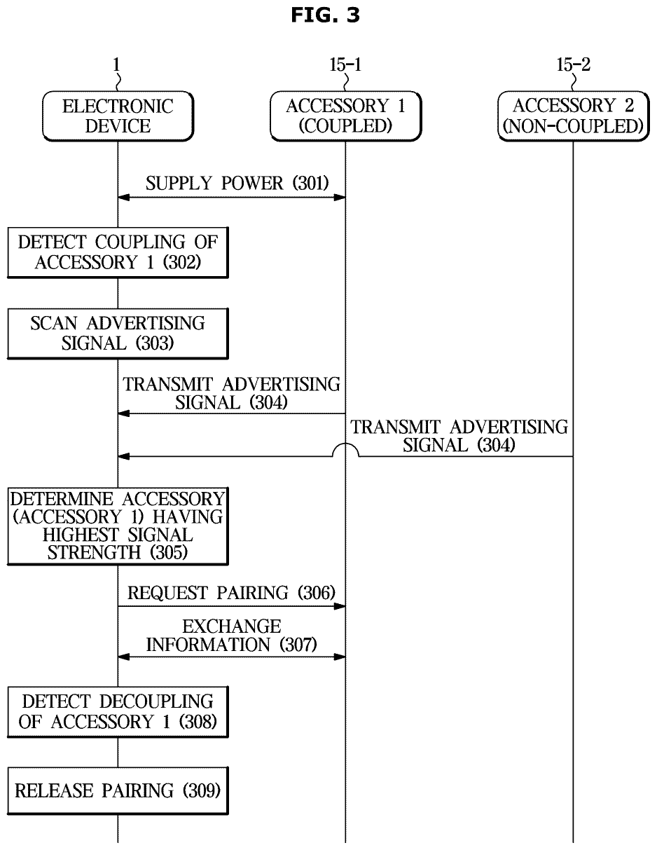

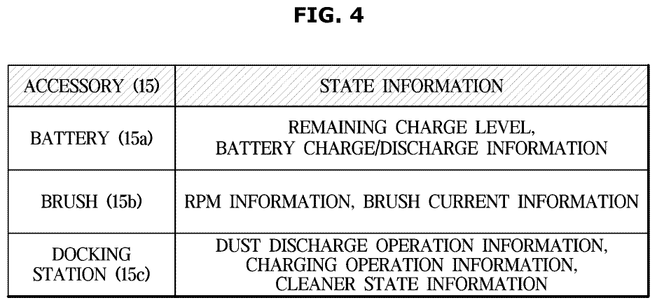

FIG. 3 is a signal flowchart of the electronic device 1 pairing with the coupled accessory 15, according to an embodiment, and FIG. 4 is a diagram for describing an example of state information transmitted or received by the electronic device 1 to or from the accessory 15, according to an embodiment.

Referring to FIG. 3, the electronic device 1 in an embodiment may start supplying power with an Caccessory 1 15-1 through a power line when the accessory 1 15-1 is coupled to the electronic device 1, in 301.

For example, when the accessory 1 15-1 is a battery, the electronic device 1 may receive power from the accessory 1 15-1 through the power line. When the accessory 1 15-1 is not a battery but an accessory requiring to receive power, the electronic device 1 may supply power received from a battery to the accessory 1 15-1 through the power line.

In an embodiment, the electronic device 1 may detect coupling of the accessory 1 15-1, in 302. Specifically, the electronic device 1 may detect coupling of the accessory 1 15-1 based on the sensing information of the sensing module 110.

For example, the electronic device 1 may detect coupling of the accessory 1 15-1 to the electronic device 1 based on detection of a voltage or current in the power line connected to the accessory 1 15-1.

Furthermore, the electronic device 1 may detect coupling of the accessory 1 15-1 to the electronic device 1 based on a change in pressure due to the coupling of the accessory 1 15-1.

In an embodiment, when detecting coupling of the accessory 1 15-1 in 302, the electronic device 1 may scan an advertising signal in 303.

In other words, the communication module 120 may scan the advertising signal transmitted from the accessory 15 when the accessory 1 15-1 is attached to.

As shown in FIG. 3, not only the accessory 1 15-1 coupled to the electronic device 1 but also an accessory 2 15-2 not coupled with the electronic device 1 may transmit the advertising signal, in 304.

For example, the accessory 2 15-2 may correspond to an extra accessory used for the electronic device 1 or an accessory used for other electronic device than the electronic device 1.

In an embodiment, the electronic device 1 may determine an accessory (e.g., accessory 1 15-1) having the highest signal strength (e.g., a receiver signal strength indicator (RSSI)) and send a request for pairing to the accessory 1 15-1 having the highest signal strength, in 306.

Specifically, the electronic device 1 may determine that the accessory 15 having the highest strength of the advertising signal corresponds to the coupled accessory 15 based on the fact that the nearer the physical distance the larger the advertising signal when the accessory 15 is coupled to the electronic device 1.

More specifically, the electronic device 1 may control the communication module 120 to pair with an accessory (accessory 1 15-1 in FIG. 3) having the highest strength of the advertising signal among the plurality of accessories 15-1 and 15-2 of the same type as the accessory 1 15-1 detected as being coupled to the electronic device 1.

In other words, the electronic device 1 may determine a type of the coupled accessory 1 15-1 based on sensing information of the sensing module 110, determine a type of the accessories 15-1 and 15-2 that transmit the advertising signal based on packet information included in the advertising signal, and control the communication module 120 to pair with the accessory (the accessory 1 15-1 in FIG. 3) having the highest strength of the advertising signal among the plurality of accessories 15-1 and 15-2 of the same type as the type of the accessory 1 15-1 detected as being coupled to the electronic device 1.

Although there are two accessories 15-1 and 15-2 described as an example in FIG. 3, the number of accessories 15 from which the electronic device 1 receives the advertising signal may vary depending on the number of accessories 15 located around the electronic device 1.

In an embodiment, after being paired, the electronic device 1 may exchange information with the accessory 1 15-1, in 307. Specifically, the electronic device 1 may control the communication module 120 to transmit or receive state information to or from the paired accessory 1 15-1.

In this case, the state information of the accessory 15 may include at least one of an operation setting value of the accessory 15 or a sensing information value. Furthermore, the state information of the electronic device 1 may include at least one of operation command information of the electronic device 1 or sensing information of the sensing module 110.

For example, when the accessory 15 corresponds to the battery 15a, the state information of the battery 15a may include remaining charge level information, battery charge/discharge information, etc. When the accessory 15 corresponds to the brush 15b, revolutions per minute (rpm) information, brush current information, etc., may be included. When the accessory 15 is the docking station 15c, state information of the docking station 15c may include dust discharge operation information, charging operation information, etc. Furthermore, the electronic device 1 may transmit its state information (cleaner state information) to the docking station 15c.

After this, in an embodiment, when detecting decoupling of the accessory 1 15-1 in 308, the electronic device 1 may release the pairing with the accessory 1 15-1 in 309.

Specifically, the electronic device 1 may control the communication module 120 to release the pairing with the accessory 1 15-1 when detecting decoupling of the accessory 1 15-1 based on sensing information (e.g., a current or voltage in the power line) of the sensing module 110.

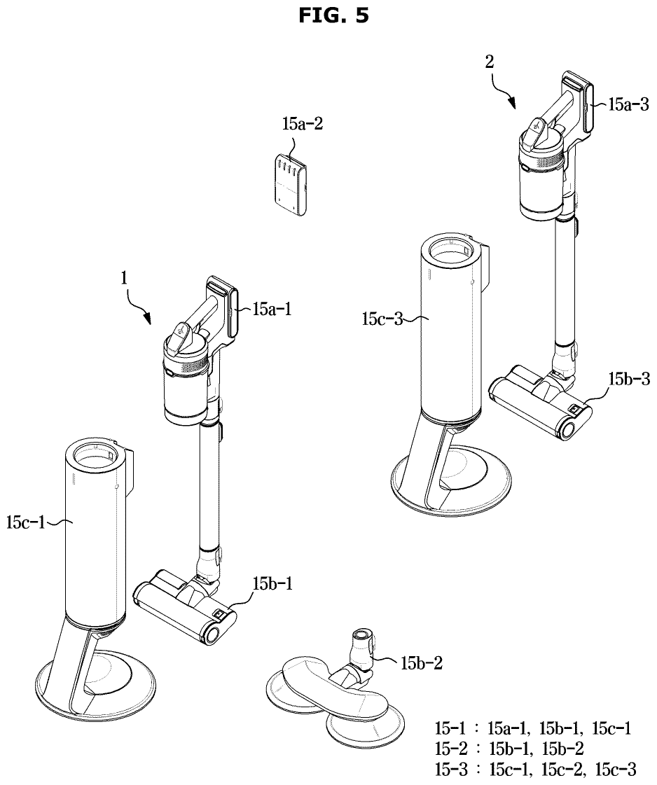

FIG. 5 is a diagram for describing an occasion when the electronic device 1 makes a wrong connection with other accessory 15 than the coupled accessory 15, according to an embodiment.

Referring to FIG. 5, the electronic device 1 in the embodiment may correspond to a vacuum cleaner that performs cleaning by sucking up debris on the floor.

To perform cleaning or other course, the electronic device 1 may be coupled to the accessory 15.

For example, the electronic device 1 may be coupled to a battery 15a-1 for supplying power, a brush 15b-1 that comes into contact with the floor to perform cleaning, and a docking station 15c-1 for discharging debris collected in the dust collection bin of the electronic device 1 or charge the battery 15a-1.

In this case, there may be extra accessories 15a-2 and 15b-2 allocated for the electronic device 1 around the electronic device 1, and there is another electronic device 2 different from the electronic device 1 and there may be accessories 15a-3, 15b-3 and 15c-3 that may be coupled to the other electronic device 2 around the electronic device 1.

In this case, the electronic device 1 may happen to be paired with the accessory 15-2 or 15-3 instead of the coupled accessory 15-1 due to noise, communication fault or a change in location between the accessories.

As such, when the electronic device 1 is paired with the accessory 15-2 or 15-3 other than the coupled accessory 15-1, the electronic device 1 may fail to obtain state information from the coupled accessory 15-1 and may thus not perform an operation intended by the user.

Hence, in an embodiment, the electronic device 1 may determine whether the paired accessory 15 corresponds to the coupled accessory 15 based on whether the state information received from the paired accessory 15 corresponds to the state information of the electronic device 1 including at least one of the operation command information or the sensing information of the sensing module 110, to determine validity of the wireless connection with the paired accessory 15 and repeatedly attempt wireless connection with the coupled accessory 15 when wrong connection is made, thereby increasing accuracy in wireless connection.

How the electronic device 1 determines validity of wireless connection with the accessory 15 will now be described in detail, and characteristics of the determination of validity depending on the type of the accessory 15 will be described.

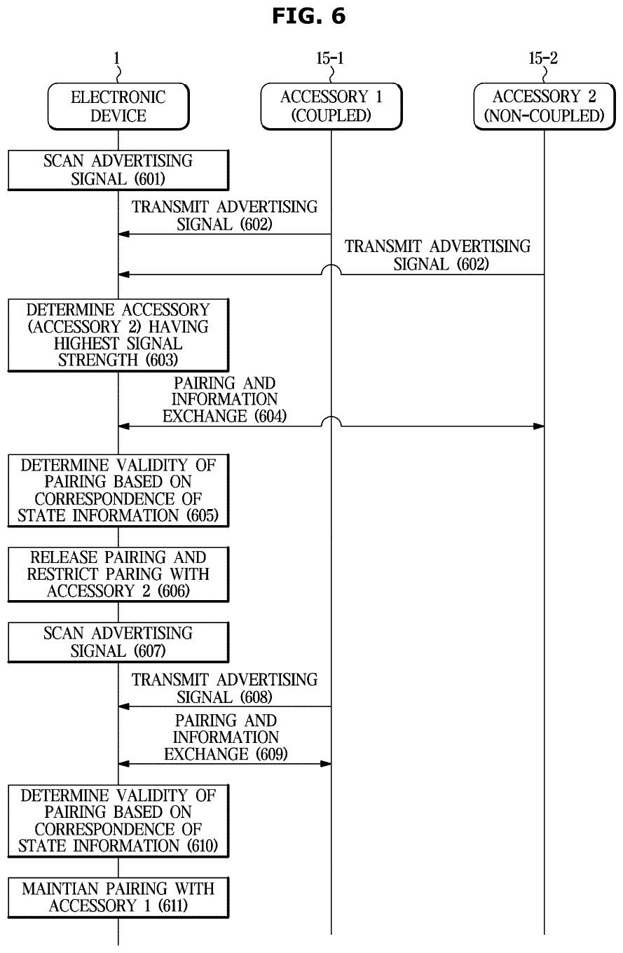

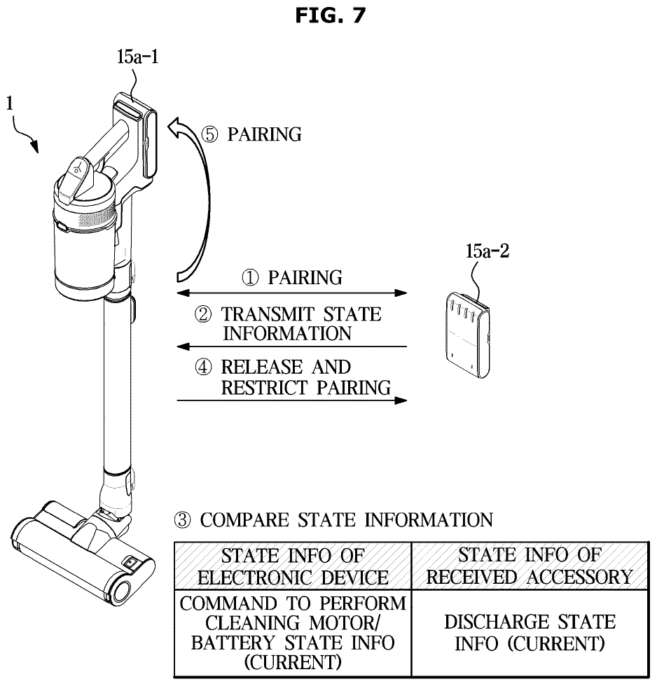

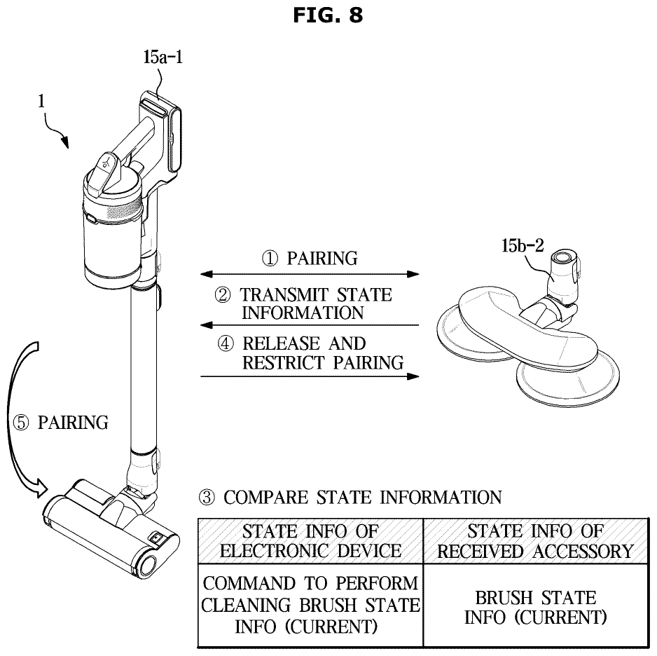

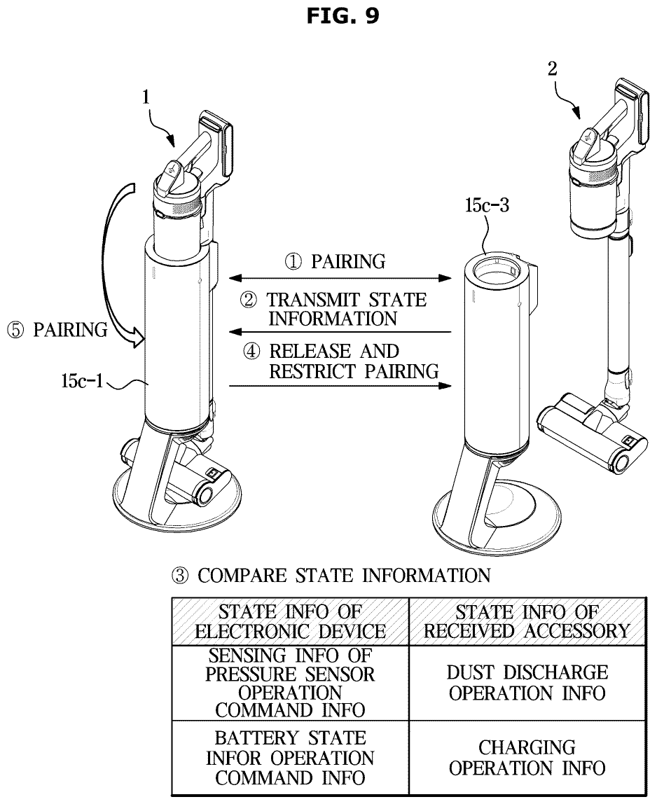

FIG. 6 is a signal flowchart of the electronic device 1 determining validity of pairing with the accessory 15, according to an embodiment, FIG. 7 illustrates an example of the electronic device 1 determining validity of pairing with the battery 15a, according to an embodiment, FIG. 8 illustrates an example of the electronic device 1 determining validity of pairing with the brush 15b, according to an embodiment, and FIG. 9 illustrates an example of the electronic device 1 determining validity of pairing with the docking station 15c, according to an embodiment.

Referring to FIG. 6, the electronic device 1 in an embodiment may scan an advertising signal in 601, and the accessory 1 15-1 coupled to the electronic device 1 and the accessory 2 15-2 not coupled with the electronic device 1 may transmit the advertising signal in 602. Although there is one accessory (the accessory 2 15-2) not coupled with the electronic device 1 in FIG. 6 and the following figures, embodiments of the disclosure are not limited thereto, and an accessory 3 15-3 coupled to the other electronic device 2 may also be included as one that transmits the advertising signal.

In an embodiment, the electronic device 1 may determine an accessory (the accessory 2 15-2) having the highest signal strength in 603, and pair with the accessory (the accessory 2 15-2) having the highest signal strength to exchange information in 604.

In this way, the electronic device 1 may be wirelessly connected to the accessory 2 15-2 instead of the accessory 1 15-1, that is the coupled accessory 15, due to noise, communication error, positional relations between the accessories 15, etc.

In an embodiment, the electronic device 1 may determine validity of pairing based on correspondence of state information, in 605.

In other words, the electronic device 1 may determine whether the paired accessory 15-2 corresponds to the coupled accessory 15-1 based on whether state information received from the paired accessory 15 corresponds to state information of the electronic device 1.

In this case, the state information of the accessory 15-2 may include at least one of an operation setting value of the accessory 15-2 or a sensing information value. Furthermore, the state information of the electronic device 1 may include at least one of operation command information of the electronic device 1 or sensing information of the sensing module 110.

For example, when the same type of accessory 15-2 as the coupled accessory 15-1 is located around the electronic device 1 and the nearby accessory 15-2 instead of the coupled accessory 1 15-1 is paired with the electronic device 1 due to noise or other reasons, the state information received from the paired accessory 15-2 may not correspond to the state information of the electronic device 1.

Specifically, when the coupled accessory 15 is the battery 15a, the electronic device 1 may determine whether the paired battery 15a corresponds to the coupled battery 15a based on whether discharge state information received from the paired battery 15a corresponds to the operation command information of the electronic device 1 or sensing information of the sensing module 110.

That is, the electronic device 1 may be paired with other battery 15a-2 than the coupled battery 15a-1 and may receive state information from the other battery 15a-2.

In this case, the electronic device 1 may determine whether the state information received from the other battery 15a-2 corresponds to the state information of the electronic device 1. For example, when the state information of the electronic device 1 indicates that cleaning is performed while the discharge state information received from the other battery 15a-2 does not indicate discharging of the current, the electronic device 1 may determine that the state information received from the other battery 15a-2 does not correspond to the state information of the electronic device 1, determine that the pairing with the other battery 15a-2 is not valid, and release and restrict the pairing with the other battery 15a-2.

In other words, when an operation command output by the controller 130 indicates that cleaning is to be performed (operation command information), a current or voltage of a suction motor (not shown) is a current or voltage from an operation (sensing information of the sensing module 110), or the state information received from the other battery 15a-2 indicates no discharging while the current or voltage of the coupled battery 15a indicates that the battery is being discharged, the electronic device 1 may determine that the other battery 15a-2 does not correspond to the coupled battery 15a-1.

For example, when the sensing information of the sensing module 110 for a discharge current of the coupled battery 15a-1 does not correspond to a discharge current indicated by the state information received from the paired battery 15a-2, the electronic device 1 may determine that the paired battery 15a-2 may not correspond to the coupled battery 15a-1.

When the electronic device 1 is a vacuum cleaner and the coupled accessory 15 is the brush 15b, the electronic device 1 may determine whether the paired brush 15b corresponds to the coupled brush based on whether the state information received from the paired brush 15b corresponds to the operation command information of the electronic device 1 or sensing information of a current applied to the coupled brush 15b.

That is, the electronic device 1 may be paired with other brush 15b-2 than the coupled brush 15b-1 and may receive state information from the other battery 15b-2.

In this case, the electronic device 1 may determine whether the state information received from the paired brush 15b-2 corresponds to the state information of the electronic device 1. For example, when the state information of the electronic device 1 indicates that cleaning is performed while the state information received from the paired brush 15b-2 does not indicate operation, the electronic device 1 may determine that the state information received from the paired brush 15b-2 does not correspond to the state information of the electronic device 1, determine that the pairing with the paired brush 15b-2 is not valid, and release and restrict the pairing with the paired brush 15b-2.

In other words, when an operation command output by the controller 130 indicates that cleaning is to be performed (operation command information) or operation current information received from the paired brush 15b-2 does not indicate operation while the current or voltage of the coupled brush 15b-1 indicates that the brush is not operating, the electronic device 1 may determine that the paired brush 15b-2 does not correspond to the coupled brush 15a-1.

As shown in FIG. 9, when the electronic device 1 is a vacuum cleaner, the coupled accessory 15 is a docking station 15c-1, and the state information received from a paired docking station 15c-2 indicates that a dust discharge course is being performed, the electronic device 1 may determine whether the paired docking station 15c-2 and the coupled docking station 15c-1 correspond to each other based on whether the sensing information of the pressure sensor of the sensing module 110 corresponds to the performing of the dust discharge course.

Specifically, the electronic device 1 may determine whether the paired docking station 15c-2 corresponds to the coupled docking station 15c-1 based on whether the state information received from the paired docking station 15c-2 corresponds to the sensing information of the pressure sensor of the sensing module 110 based on the fact that pressure changes in the vacuum cleaner according to the airflow sucked in at the docking station 15c when the dust discharge course is performed.

For example, as shown in FIG. 9, when the sensing information of the pressure sensor of the sensing module 110 indicates a change in pressure even though the electronic device 1 receives, from the paired docking station 15c-2, the state information indicating that the dust discharge operation is not performed, the electronic device 1 may determine that the state information received from the paired docking station 15c-2 does not correspond to the sensing information of the pressure sensor of the sensing module 110, and determine that the paired docking station 15c-2 does not correspond to the coupled docking station 15c-1.

When the sensing information of the pressure sensor of the sensing module 110 indicates a change in pressure after the electronic device 1 transmits operation command information to instruct termination of the dust discharge course to the coupled docking station 15c-1, the electronic device 1 may determine that the state information received from the paired docking station 15c-2 does not correspond to the sensing information of the pressure sensor of the sensing module 110, and determine that the paired docking station 15c-2 does not correspond to the coupled docking station 15c-1.

As shown in FIG. 9, when the electronic device 1 is a vacuum cleaner, the coupled accessory 15 is the docking station 15c-1, and the state information received from the paired docking station 15c-2 indicates that a charging course is performed, the electronic device 1 may determine whether the paired docking station 15c-2 corresponds to the coupled docking station 15c-1 based on whether the state information corresponds to the operation command information of the electronic device 1 or sensing information of a charge current of the coupled battery 15a.

Specifically, the electronic device 1 may determine whether the paired docking station 15c-2 corresponds to the coupled docking station 15c-1 based on whether the state information received from the paired docking station 15c-2 corresponds to the sensing information of the charge current of the coupled battery 15a based on the fact that the current from the battery 15a changes when the battery charge course is performed by the docking station 15c.

For example, when the electronic device 1 receives sensing information of the sensing module 110 indicating that a charge current flows to the coupled battery 15a or sensing information of the sensing module 110 indicating that the battery 15a is not fully charged after receiving, from the paired docking station 15c-2, state information indicating that no charge current flows from the paired docking station 15c-2, the electronic device 1 may determine that the state information received from the paired docking station 15c-2 does not correspond to the sensing information of the charge current of the coupled battery 15c and determine that the paired docking station 15c-2 does not correspond to the coupled docking station 15c-1.

When the electronic device 1 receives state information indicating that a charge current flows from the paired docking station 15c-2 after the electronic device 1 transmits operation command information instructing termination of charging to the coupled docking station 15c-1, the electronic device 1 may determine that the state information received from the paired docking station 15c-2 does not correspond to the operation command information and determine that the paired docking station 15c-2 does not correspond to the coupled docking station 15c-1.

In an embodiment, when determining that the coupled accessory 1 15-1 and the paired accessory 2 15-2 do not correspond to each other, the electronic device 1 releases the pairing with the paired accessory 2 15-2 and restricts pairing with the accessory 2 15-2, in 606.

For example, when determining that the paired accessory 2 15-2 does not correspond to the coupled accessory 1 15-1, the electronic device 1 may add the accessory 2 15-2 to a wrong connection list and restrict pairing with the accessory 2 15-2.

Aftermath, the electronic device 1 may re-perform a course of scanning the advertising signal, in 607. In this case, the accessory 1 15-1 may transmit the advertising signal to the electronic device 1 in 608, and the electronic device 1 may be paired with the accessory 1 15-1 having the highest signal strength to exchange information in 609.

The electronic device 1 may determine validity of the pairing based on correspondence of state information in 610, and maintain the pairing with the accessory 1 15-1 when determining that the coupled accessory 1 15-1 is the paired accessory 1 15-1, in 611.

An embodiment of a method of controlling the electronic device 1 will now be described according to an aspect. As for the method of controlling the electronic device 1, the electronic device 1 in the aforementioned embodiments may be used. Hence, what are described above with reference to FIGS. 1 to 9 may be equally applied in the following method of controlling the electronic device 1.

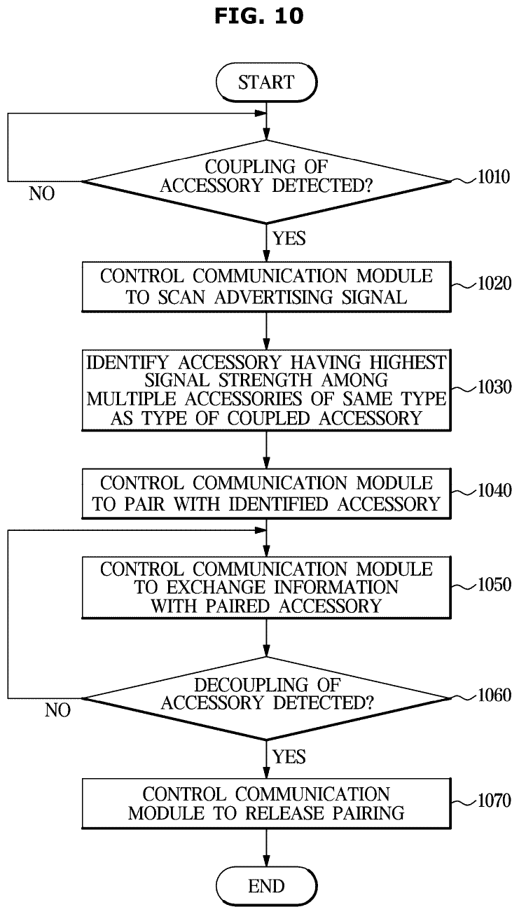

FIG. 10 is a flowchart of performing wireless connection with the accessory 15 in a method of controlling the electronic device 1, according to an embodiment.

Referring to FIG. 10, when coupling of the accessory 15 is detected in 1010, the electronic device 1 may control the communication module 120 to scan the advertising signal, in 1020.

For example, the electronic device 1 may detect coupling of the accessory 15 based on the sensing information of the sensing module 110, and control the communication module 120 to scan the advertising signal transmitted from the detected accessory 15.

In an embodiment, the electronic device 1 may identify the accessory 15 having the highest signal strength among a plurality of accessories of the same type as the coupled accessory 15 in 1030, and control the communication module 120 to pair with the identified accessory 15 in 1040.

Specifically, the electronic device 1 may determine that the accessory 15 having the highest strength of the advertising signal corresponds to the coupled accessory 15 based on the fact that the nearer the physical distance the larger the advertising signal when the accessory 15 is coupled to the electronic device 1.

In other words, the electronic device 1 may determine a type of the coupled accessory 15 based on sensing information of the sensing module 110, determine a type of the accessory that transmits the advertising signal based on packet information included in the advertising signal, and control the communication module 120 to pair with the accessory 15 having the highest strength of the advertising signal among the plurality of accessories of the same type as the type of the accessory 15 detected as being coupled to the electronic device 1.

Furthermore, the electronic device 1 may control the communication module 120 to transmit or receive state information to or from the paired accessory 1 15-1.

In this case, the state information of the accessory 15 may include at least one of an operation setting value of the accessory 15 or a sensing information value. Furthermore, the state information of the electronic device 1 may include at least one of operation command information of the electronic device 1 or sensing information of the sensing module 110.

In an embodiment, when decoupling of the accessory 15 is detected in 1060, the electronic device 1 may control the communication module 120 to release the pairing with the accessory 15, in 1070.

Specifically, the electronic device 1 may control the communication module 120 to release the pairing with the accessory 15 when detecting decoupling of the accessory 15 based on the sensing information (e.g., a current or voltage in the power line) of the sensing module 110.

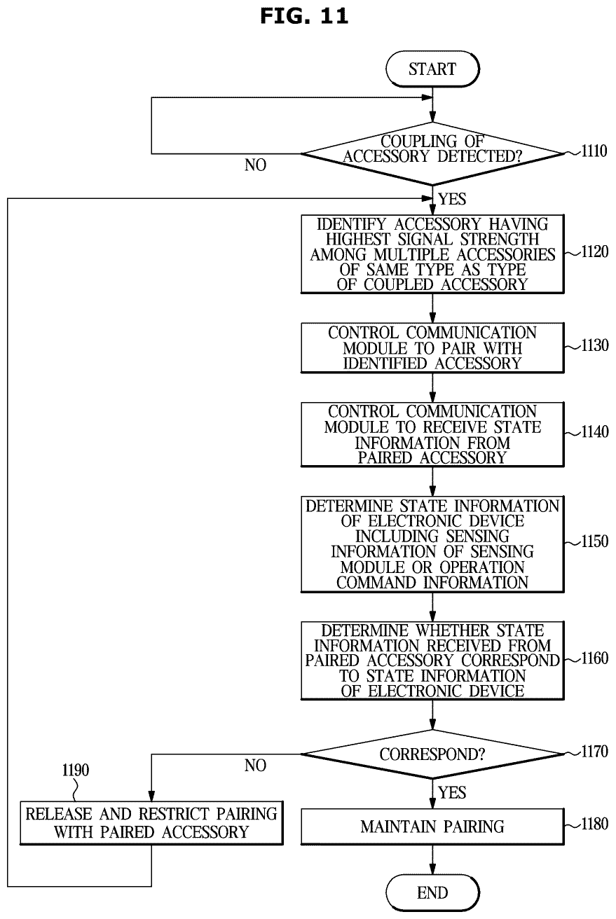

FIG. 11 is a flowchart of determining validity of wireless connection with the accessory 15 in a method of controlling the electronic device 1, according to an embodiment.

Referring to FIG. 11, when detecting coupling of the accessory 15 in 1110, the electronic device 1 may identify the accessory 15 having the highest signal strength among the plurality of accessories 15 of the same type as the coupled accessory 15 in 1120, control the communication module 120 to pair with the identified accessory 15, in 1130, and control the communication module 120 to receive state information from the paired accessory 15 in 1140.

In an embodiment, the electronic device 1 may determine state information of the electronic device 1 including sensing information of the sensing module 110 or operation command information, in 1150.

Specifically, the electronic device 1 may determine state information of the electronic device 1 including at least one of sensing information or operation command information and indicating a state of the electronic device 1.

In an embodiment, the electronic device 1 may determine whether the state information received from the paired accessory 15 corresponds to the state information of the electronic device 1 in 1160, and in case of yes in 1170, maintain the pairing with the paired accessory 15 in 1180, and in case of no in 1170, release and restrict the pairing with the paired accessory 15 in 1190, and re-perform the pairing procedure in 1120 to 1190.

For example, when the same type of accessory 15 as the coupled accessory 15 is located around the electronic device 1 and the nearby accessory 15 other than the coupled accessory 15 is paired with the electronic device 1 due to noise or other reasons, the state information received from the paired accessory 15 may not correspond to the state information of the electronic device 1.

Hence, the electronic device 1 may determine whether the paired accessory 15 corresponds to the coupled accessory 15 based on whether the state information received from the paired accessory 15 corresponds to the state information of the electronic device 1 including at least one of the operation command information or the sensing information of the sensing module 110, to determine validity of wireless connection with the paired accessory 15 and repeatedly attempt wireless connection with the coupled accessory 15 when a wrong connection is made, thereby increasing accuracy in wireless connection.

Meanwhile, the embodiments of the disclosure may be implemented in the form of a recording medium for storing instructions to be carried out by a computer. The instructions may be stored in the form of program codes, and when executed by a processor, may generate program modules to perform operations in the embodiments of the disclosure. The recording media may correspond to computer-readable recording media.

The computer-readable recording medium includes any type of recording medium having data stored thereon that may be thereafter read by a computer. For example, it may be a read only memory (ROM), a random access memory (RAM), a magnetic tape, a magnetic disk, a flash memory, an optical data storage device, etc.

The embodiments of the disclosure have thus far been described with reference to accompanying drawings. It will be obvious to those of ordinary skill in the art that the disclosure may be practiced in other forms than the embodiments of the disclosure as described above without changing the technical idea or essential features of the disclosure. The above embodiments of the disclosure are only by way of example, and should not be construed in a limited sense.

What is claimed is:

1. An electronic device comprising:
at least one sensor;
a communicator including circuitry configured to perform wireless communication;
an accessory detachably coupled to the electronic device; and
at least one processor configured to:
based on detecting coupling of the accessory to the electronic device, control the communicator to execute pairing with the accessory, and
validate the pairing with the accessory based on at least one of state information or operation information received from the accessory corresponding to at least one of operation command information transmitted to the accessory or sensing information of the at least one sensor.

2. The electronic device of claim 1, wherein the accessory includes a moving device, and
the at least one of the state information or the operation information includes torque information.

3. The electronic device of claim 1, wherein the accessory includes a moving device, and
the at least one of the state information or the operation information includes at least one of position information or velocity information.

4. The electronic device of claim 1, wherein the accessory includes an articulated device having a joint, and
the at least one of the state information or the operation information includes joint angle information.

5. The electronic device of claim 1, wherein the accessory includes an articulated device configured to perform at least one of gripping an object, lifting the object, manipulating the object, supporting the electronic device, or moving the electronic device.

6. The electronic device of claim 1, wherein the accessory includes a moving device having a motor,
and the at least one of the state information or the operation information includes motor current information.

7. The electronic device of claim 1, wherein the at least one of the state information or the operation information received from the accessory includes output information indicating at least one of a light emission, a display output, or a sound output of the accessory.

8. The electronic device of claim 1, wherein each of a plurality of accessories is attachable to the electronic device, and
the at least one processor is configured to independently execute pairing and determine validity of pairing for the each of the plurality of accessories.

9. The electronic device of claim 1, wherein the at least one processor is configured to release the pairing with the accessory based on the pairing being determined as invalid.

10. The electronic device of claim 1, wherein the at least one processor is configured to, based on an output of the at least one sensor detecting decoupling of the accessory from the electronic device, control the communicator to release the pairing with the accessory.

11. A method of controlling an electronic device, the method comprising:
based on detecting coupling of an accessory to the electronic device, controlling a communicator to execute pairing with the accessory; and
validating the pairing with the accessory based on at least one of state information or operation information received from the accessory corresponding to at least one of operation command information transmitted to the accessory or sensing information of at least one sensor.

12. The method of claim 11, wherein the accessory includes a moving device, and
the at least one of the state information or the operation information includes torque information.

13. The method of claim 11, wherein the accessory includes a moving device, and
the at least one of the state information or the operation information includes at least one of position information or velocity information.

14. The method of claim 11, wherein the accessory includes an articulated device having a joint, and
the at least one of the state information or the operation information includes joint angle information.

15. The method of claim 11, wherein the accessory includes an articulated device configured to perform at least one of gripping an object, lifting the object, manipulating the object, supporting the electronic device, or moving the electronic device.

16. The method of claim 11, wherein the accessory includes a moving device having a motor, and
the at least one of the state information or the operation information includes motor current information.

17. The method of claim 11, wherein the at least one of the state information or the operation information received from the accessory includes output information indicating at least one of a light emission, a display output, or a sound output of the accessory.

18. The method of claim 11, wherein each of a plurality of accessories is attachable to the electronic device, and
the method further comprises independently executing pairing and determining validity of pairing for the each of the plurality of accessories.

19. The method of claim 11, further comprising:
releasing the pairing with the accessory based on the pairing being determined as invalid.

20. The method of claim 11, further comprising:
based on an output of the at least one sensor detecting decoupling of the accessory from the electronic device, controlling the communicator to release the pairing with the accessory.
